(19) United States
(12) Patent Application Publication
(10) Pub. No.: US 2002/0104940 A1
(43) Pub. Date: Aug. 8, 2002

(54) Fiberglass duct board mounting plate

(76) Inventor: Steve Guzorek, Kinston, NC (US)

Correspondence Address: John G. Bisbikis, McDermott, Will & Emery, 31st Floor, 227 West Monroe Street, Chicago, IL, 60606, US

(21) Appl. No.: 09/767,157

(22) Filed: Jan. 22, 2001

(51) Int. Cl. A47K 1/00; F16L 3/08

(52) U.S. Cl. 248/226.11

(57) ABSTRACT

A mounting plate that can be secured to a duct, the mounting plate comprising a mounting portion; and a moveable tab attached to the mounting portion, the tab including a gripping portion whereby the tab can be bent to allow the gripping portion to engage the duct thereby securing the mounting plate to the duct.

### FIELD OF THE INVENTION

The present invention relates to a mounting plate designed to mount an object to an air duct. Specifically, the present invention relates to a mounting plate for mounting an ultraviolet (“UV”) device or other device to a fiberglass air duct, wherein the mounting plate has a tab used to secure the mounting plate to the duct board. Further, the mounting plate can be used as a template for cutting and removing a portion of a duct board prior to securing the mounting plate to the exterior of the duct.

### BACKGROUND OF THE INVENTION

It is common in the heating, ventilation, and air-conditioning (“HVAC”) industry to mount devices within air ducts to treat or improve the quality of air in the system. For example, UV light devices, humidifiers, etc. are often mounted within air ducts. Traditionally, the mounting brackets for UV lamps and other devices have been screwed directly into the walls of metal air ducts. However, it is often desirable to employ fiberglass air ducts rather than metal air ducts. Fiberglass ducts generally consist of a thin layer of aluminum covering the exterior side of approximately one-inch of fiberglass material. Compared to metal air ducts, fiberglass ducts provide less structural support for mounting devices thereto. Therefore, devices mounted to fiberglass ducts have traditionally been less secure than devices mounted to metal ducts. For example, a fiberglass air duct is not capable of supporting an UV light device screwed directly to the duct. Rather than screwing an UV light into a fiberglass air duct, such devices have been duct taped to the fiberglass duct. This mounting configuration is not adequately stable for properly mounting such a device.

An additional concern when mounting devices within air ducts has been whether the device can be mounted, and thereby maintained or replaced, from outside the duct. If not, additional steps are required to gain access to the interior of the duct. Furthermore, restricted access to the air duct is a concern when mounting devices within air ducts. Often air ducts are located within a structure that limits access to multiple sides of the air duct. Accordingly it would be desirable to provide a mounting plate capable of securely attaching a device to a fiberglass duct board, from outside the duct, requiring access to only one side of the duct.

### SUMMARY OF THE INVENTION

It is one of the principle objects of the present invention to provide a mounting plate that can be used to mount a device to a fiberglass duct board of an air duct such as is currently used in HVAC systems.

It is another object of the present invention to provide a mounting plate that can be secured to a fiberglass duct board using a tab of the mounting plate as a clamping mechanism.

It is still further an object of the present invention to provide a mounting plate that can be used to mount a device within a duct where access to more than one exterior wall of the duct is limited.

It is yet another object of the present invention to provide a mounting plate that can be used for mounting any of a plurality of devices, such as UV lamps, humidifiers, et cetera.

It is another object of the present invention to provide a mounting plate that is easy to mount to a fiberglass air duct.

These and other objects of the present invention will become apparent upon examining the drawings and figures together with the accompanying written description thereof.

### BRIEF DESCRIPTION OF DRAWINGS

FIG. 1 is a top plan view of a mounting plate of the present invention in its initial configuration.

FIG. 2 is a perspective view of a mounting plate of the present invention in a second position where the mounting plate can be used as a template for cutting an opening in the air duct.

FIG. 3 is a side plan view of a mounting plate of the present invention in a third position that occurs during the transition between the second position illustrated in FIG. 2 and the final position illustrated in FIG. 4.

FIG. 4 is a side plan view of a mounting plate of the present invention in its final secure mounting position.

### DETAILED DESCRIPTION OF THE DRAWINGS

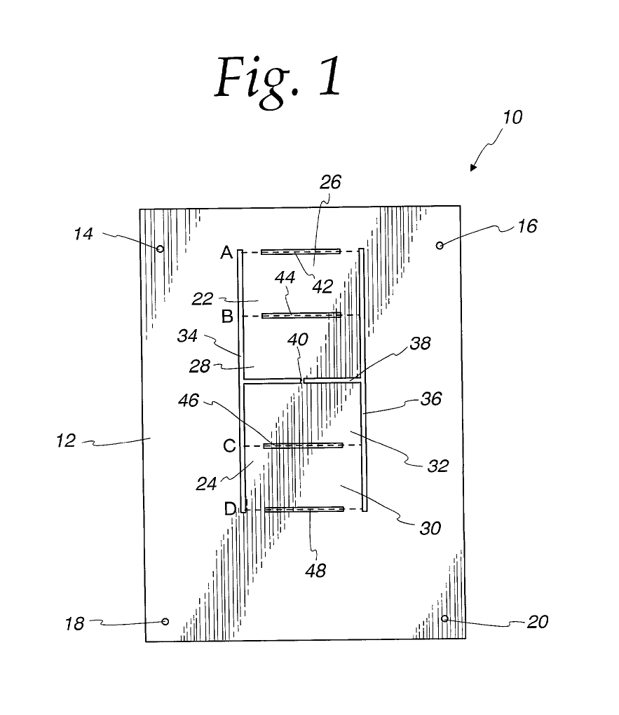

FIG. 1 illustrates an embodiment of the present invention showing a mounting plate 10 in its initial configuration. As shown in FIG. 1, the mounting plate 10 has a mounting portion 12. The mounting portion 12 has four mounting holes 14, 16, 18, and 20 therein. The holes are positioned for attaching device to the mounting plate 10 by means of screws or bolts after the mounting plate has been secured to the air duct. Additionally, the mounting plate 10 has an upper tab 22 and a lower tab 24 for securing the mounting plate 10 to a fiberglass duct board (not shown). In the embodiment illustrated in FIG. 1, the mounting plate 10 has been configured for mounting a particular UV light device (not shown) thereto. The configuration of the mounting holes 14, 16, 18, and 20 and the tabs 22 and 24 can be adjusted to accommodate other devices. For example, the mounting plate 10 might not include the mounting holes 14, 16, 18, and 20. In such case, the operator could drill appropriate mounting holes at the time of installation.

The upper tab 22 has a spacing portion 26 and a gripping portion 28. Likewise, the lower tab 24 has a spacing portion 30 and a gripping portion 32. The length of the spacing portions 26 and 30 is designed to match the width of the fiberglass duct board to which the mounting plate 10 is to be attached, as described below. The size of the gripping portions 28 and 32 is designed to provide adequate support so that, when the mounting plate 10 is secured to the duct, a device can be securely attached to the mounting plate 10, as described below. A left slot 34 separates the left sides of the tabs 22 and 24 from the mounting portion 12 of the mounting plate 10. A right slot 36 separates the right sides of the tabs 22 and 24 from the mounting portion 12 of the mounting plate 10. A middle slot 38 further separates the upper tab 22 from the lower tab 24. The tabs 22 and 24 are held in their initial configuration by a locking element 40 that spans the middle slot 38 connecting the upper tab 22 and the lower tab 24. The locking element 40 provides stability to the initial configuration of the mounting plate 10, yet can be easily removed by an operator at the time of installation.

With the locking element 40 removed, the tabs 22 and 24 can be bent along what is shown as lines A, B, C, and D. Bend line A is a line between the mounting portion 12 of the mounting plate 10 and the spacing portion 26 of the upper tab 22. Bend line B is a line between the spacing portion 26 of the upper tab 22 and the gripping portion 28 of the upper tab 22. Bend line C is a line between the gripping portion 32 of the lower tab 24 and the spacing portion 30 of the lower tab 24. Bend line D is a line between the spacing portion 30 of the lower tab 24 and the mounting portion 12 of the mounting plate 10. The mounting plate 10 has slots 42, 44, 46, and 48 that are located along bend lines A, B, C, and D respectively. The slots 42, 44, 46, and 48 facilitate bending of the tabs 22 and 24 by hand along their respective bend lines A, B, C, and D. In place of, or in addition to, the slots 42, 44, 46, and 48, the mounting plate 10 can be scored, perforated, or notched along lines A, B, C, and D to enable the tabs 22 and 24 to be bent by hand.

In the embodiment illustrated in FIG. 1, the mounting plate 10 is manufactured from a single piece of material by punching material from a mounting plate blank (not shown) to form the mounting holes 14, 16, 18, and 20 and the slots 34, 36, 38, 42, 44, 46, and 48 of the present invention. Alternatively, the mounting plate 10 can be formed using a stamping process. The mounting plate 10 is preferably formed of coated steel, such as a stainless or carbon steel. Alternately, the mounting plate 10 can be formed of another material sufficiently strong to support a device when mounted to an air duct, yet sufficiently pliable to enable the tabs 22 and 24 to be bent by hand. For example, some plastics or aluminum may be unable to provide adequate support or remain sufficiently pliable.

In the embodiment of the present invention illustrated in FIG. 1, the mounting plate 10 has an overall width of 5.000 inches and an overall height of 6.750 inches. Each of the mounting holes 14, 16, 18, and 20 are 0.125 inches in diameter. Each of the mounting holes 14, 16, 18, and 20 are located 0.298 inches from the nearest vertical edge of the mounting plate 10. The top two mounting holes 14 and 16 are located 0.580 inches from the top edge of the mounting plate 10. The bottom two mounting holes 18 and 20 are located 0.330 inches from the bottom edge of the mounting plate 10. The tabs 22 and 24 are each 1.954 inches in height and 1.814 inches in width. The spacing portions 26 and 30 of each tab 22 and 24 are 1.002 inches in height. The gripping portions 28 and 32 of each tab 22 and 24 are 0.952 inches in height. Each of the slots 34, 36, 38, 42, 44, 46, and 48 is 0.093 inches in width. Slots 42, 44, 46, and 48 along bend lines A, B, C, and D are 1.314 inches in length and are centered between the left and right vertical edges of each tab 22 and 24 as well as being centered between each intersection of the mounting portion 12 with the spacing portions 26 and 30 and the spacing portions 26 and 30 with the gripping portions 28 and 32.

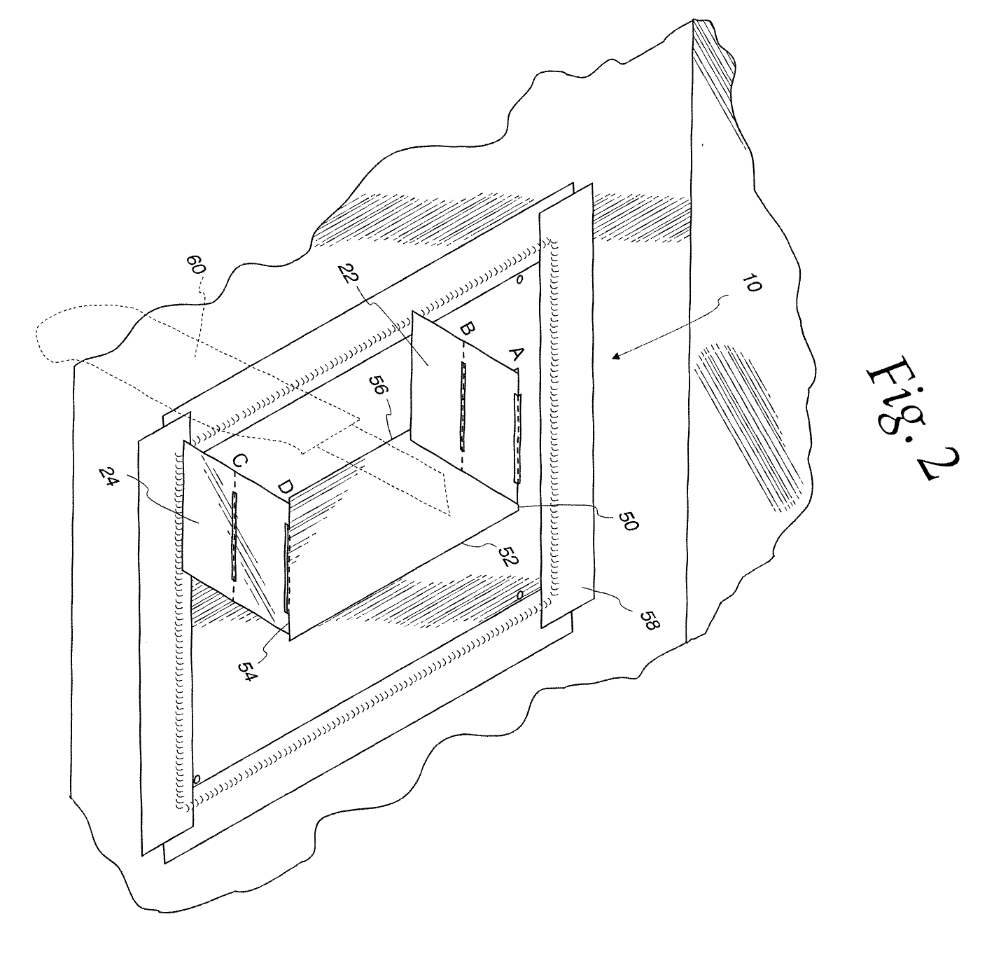

To secure the mounting plate 10 to an air duct, the mounting plate 10 can be attached to the outer surface of a fiberglass duct board in its initial configuration, as shown in FIG. 1, by an attaching means 58 (shown in FIG. 2). For example, duct tape can be used as the attaching means 58 for attaching the mounting plate 10 to the outer surface of a fiberglass duct board. The attaching means 58 must be capable of holding the mounting plate 10 in place on the duct board until the mounting plate 10 is secured to the duct board as described below. However, the attaching means 58 is not required to be strong enough to support the mounting plate 10 when a device is mounted to it. Preferably, the attaching means 58 is capable of sealing the mounting plate 10 to the fiberglass duct to prevent the mounting connection from leaking air.

Referring now to FIG. 2, once the mounting plate 10 has been attached to a fiberglass duct board using the attaching means 58, and the locking element 40 has been removed, the upper tab 22 and the lower tab 24 of the mounting plate 10 can be bent away from the duct board along bending lines A and D respectively. In this position, a cutting device 60, such as a knife, blade, or other cutting device, can be used to cut and remove a section of the duct to create an opening in the duct board. The exposed interior edges 50, 52, 54, and 56 of the mounting plate 10 along the left slot 34, the right slot 36 and bend lines A and D provide an outline or a cutting template for cutting the exposed portion of the duct board. Once the cut section is removed, the opening in the duct provides internal access to the duct for a device that is to be mounted to the mounting plate 10.

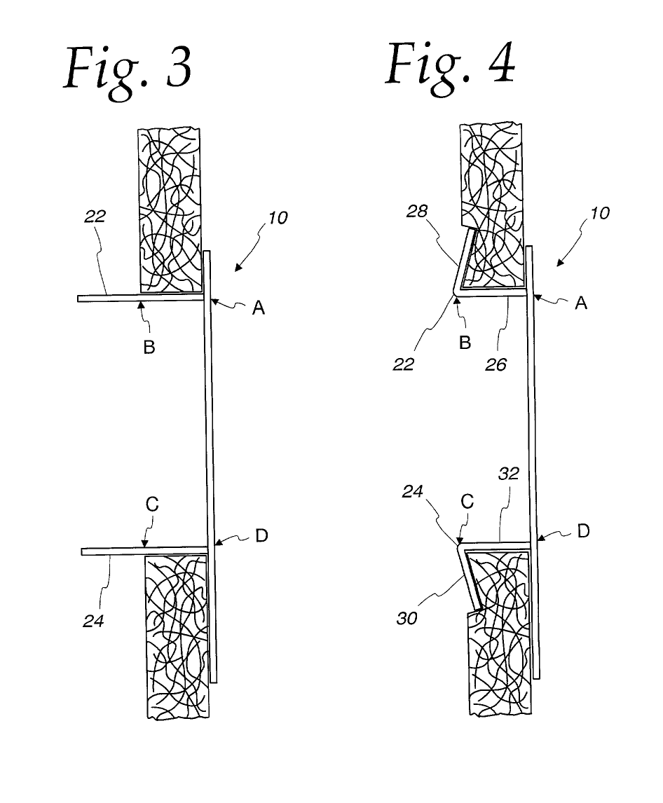

After an opening has been created in the duct, the upper tab 22 and the lower tab 24 can be bent along bend lines A and D such that the tabs 22 and 24 extend into the duct, as illustrated in FIG. 3.

The gripping portion 28 of the upper tab 22 can then be bent upwardly as illustrated in FIG. 4, along bend line B, to pinch and grip the interior wall of the duct. Likewise, the gripping portion 32 of the lower tab 24 can be bent downwardly along bend line C to pinch and grip the inner wall of the duct. When the tabs 22 and 24 are bent along these lines, the mounting plate 10 is in its final mounting position. Duct boards generally have an inner wall made of fiberglass, which can be compressed. The thickness of fiberglass ducts can vary, but typical wall thickness of a duct is approximately one inch. The tabs 22 and 24 are bent such that when the gripping portions 28 and 32 grip the inner wall of the duct, the fiberglass material is compressed, thereby securing the mounting plate 10 in place on the duct. Once the mounting plate 10 has been secured to the duct board, a device can be mounted to the mounting plate 10 using the mounting holes 14, 16, 18, and 20 therein. A device can be mounted to the mounting plate 10 using screws or any other mounting means.

From the foregoing description, it will be apparent that the mounting plate of the present invention has a number of advantages, some of which have been described above and others of which are inherent in the system described herein. Also, it will be understood that modifications can be made to the device of the present invention without departing from the teachings hereof. Accordingly the scope of the invention is only to be limited as necessitated by the accompanying claims.

We claim:

1. A mounting plate that can be secured to a fiberglass duct having a thickness, said mounting plate comprising:
a mounting portion; and
a moveable tab attached to said mounting portion,
said tab including a gripping portion, whereby said tab can be bent to allow said gripping portion to engage the duct thereby securing said mounting plate to the duct.

2. The mounting plate of claim 1 wherein said mounting portion further comprises a plurality of mounting holes located therein for mounting a device to the mounting plate.

3. The mounting plate of claim 2 wherein said plurality of mounting holes further comprises at least four mounting holes.

4. The mounting plate of claim 1 wherein said mounting plate has an upper tab and a lower tab.

5. The mounting plate of claim 4 further comprising a removable locking element connecting said gripping portions of said upper tab and said lower tab.

6. The mounting plate of claim 4 wherein each tab further comprises a spacing portion between said gripping portion and said mounting portion of said mounting plate.

7. The mounting plate of claim 6 wherein said spacing portion is as long as the duct is thick, as measured from said mounting portion to said gripping portion.

8. The mounting plate of claim 6 wherein said tab further comprises a slot between said gripping portion and said spacing portion.

9. The mounting plate of claim 6 wherein each tab further comprises one or more areas of increased flexibility to facilitate bending of said tabs between said gripping portions, said spacing portions, and said mounting portion.

10. The mounting plate of claim 1 wherein said tab further comprises a spacing portion between said gripping portion and said mounting portion of said mounting plate.

11. The mounting plate of claim 10 wherein said tab further comprises one or more areas of increased flexibility to facilitate bending of said tab between said gripping portion, said spacing portion, and said mounting portion.

12. The mounting plate of claim 1 wherein said mounting portion is rectangular.

13. The mounting plate of claim 1 wherein the said mounting portion and said plurality of clamping portions are formed from a single sheet of steel.

14. The mounting plate of claim 1 wherein said mounting plate further comprises at least one area of increased flexibility between said mounting portion and said tab to facilitate bending of said tab.

15. A mounting plate for mounting an object to a fiberglass duct board comprising:
a mounting portion;
a plurality of mounting holes;
a plurality of moveable tabs attached to said mounting portion, said tabs further comprising a spacing portion moveable relative to the mounting portion and a gripping portion moveable relative to said spacing portion.

16. A method of securing a mounting plate to a fiberglass duct board comprising the steps of:
1. providing a mounting plate comprising:
a mounting portion;
a moveable tab attached to said mounting portion, said tab further comprising a spacing portion and a gripping portion;
2. providing an opening in a section of fiberglass duct board;
3. bending said tab into the opening in the fiberglass duct board;
4. bending said gripping portion of said tab relative to said spacing portion of said tab to secure the mounting plate to said duct.
